(19) United States
(12) Patent Application Publication
(10) Pub. No.: US 2026/0092873 A1
(43) Pub. Date: Apr. 2, 2026

(54) TOP PLATE FOR INSPECTION SYSTEM

(71) Applicant: Onto Innovation Inc., Wilmington, MA (US)

(72) Inventors: Stephen W. Into, Hudson, NH (US); Alex Farias, Beaverton, OR (US)

(21) Appl. No.: 19/296,063

(22) Filed: Aug. 11, 2025

Related U.S. Application Data
(60) Provisional application No. 63/701,047, filed on Sep. 30, 2024.

(51) Int. Cl. G01N 21/88; G01N 21/95

(52) U.S. Cl. CPC G01N 21/8806; G01N 21/9501; G01N 2201/021

(57) ABSTRACT

A top plate design is described that allows a quick change of the reflector plates, for example, in the top plate assembly. Using various techniques, the reflector plates or, in some examples, sources of illumination, are held in place by a vacuum during operation. This technique holds the reflector plates securely without top-side fixturing, maximizing the available active area of a substrate. A vacuum secures the panel or wafer without contacting the active areas, allowing for non-contact inspection and metrology. The top plate also facilitates the use of interchangeable reflector plates, enabling backlit or reflective illumination of the substrate’s features.

### CLAIM OF PRIORITY

This application claims the benefit of priority of U.S. Provisional Patent Application Serial Number 63/701,047, titled “TOP PLATE FOR INSPECTION SYSTEM” to Stephen W. Into et al., filed on September 30, 2024, the entire contents of which being incorporated herein by reference.

### FIELD OF THE DISCLOSURE

This document pertains generally, but not by way of limitation, to inspection systems for semiconductor and electronics manufacturing.

### BACKGROUND

Inspection systems play an important role in ensuring the quality and reliability of integrated circuits (ICs). As the electronics industry advances, the demand for precise and efficient inspection methods has grown, driven by the need to detect defects and ensure the integrity of complex structures, such as semiconductor wafers and panels such as through glass vias (TGVs) panels.

Inspection systems are designed to provide detailed analysis of various parameters, including dimensions, roundness, and alignment of features on substrates. These systems often use advanced imaging techniques, such as reflective and transmitted light microscopy, to capture high-resolution images of the components under inspection.

### SUMMARY OF THE DISCLOSURE

This disclosure describes a top plate design that allows a quick change of the reflector plates, for example, in the top plate assembly. Using various techniques of this disclosure, the reflector plates or, in some examples, sources of illumination, are held in place by a vacuum during operation. This technique holds the reflector plates securely without top-side fixturing, maximizing the available active area of the substrate. A vacuum secures the panel or wafer without contacting the active areas, allowing for non-contact inspection and metrology. The top plate also facilitates the use of interchangeable reflector plates, enabling backlit or reflective illumination of the panel’s features.

In some aspects, this disclosure is directed to a top plate for an inspection system, comprising: a substrate zone configured to hold a substrate in place using a vacuum system, wherein the substrate zone is designed to prevent contact with active areas of the substrate; and a reflector zone configured to hold a reflector plate positioned beneath the substrate in place using the vacuum system.

In some aspects, this disclosure is directed to a top plate for an inspection system, comprising: a substrate zone configured to hold a substrate in place using a vacuum system, wherein the substrate zone is designed to prevent contact with active areas of the substrate; and an illumination zone configured to hold an illumination source positioned beneath the substrate in place using the vacuum system.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a perspective view of an example of a top plate of an inspection system in accordance with this disclosure.

FIG. 2 is a top-down view of the top plate of FIG. 1 including reflector plates.

FIG. 3A is a top-down view of the top plate of FIG. 1 including a panel.

FIG. 3B is an exploded view of the top-down view of FIG. 3A.

FIG. 4 is a cross-sectional view of an example of a portion of the top plate including a reflector plate and a panel in accordance with this disclosure.

FIG. 5 is a bottom view of the top plate of FIG. 1.

FIG. 6 is a perspective view of an example of a lift pin mechanism coupled with the top plate of FIG. 1.

FIG. 7 is a perspective view of the lift pin mechanism of FIG. 6 shown in an actuated state.

FIG. 8 is a perspective view of the lift pin mechanism of FIG. 6 shown in isolation with the top plate.

FIG. 9 is an exploded view depicting the top plate of FIG. 3A with an example of an adapter plate.

FIG. 10 depicts examples of a substrate.

### DETAILED DESCRIPTION

With the transition from traditional materials like silicon and organic compounds to glass substrates in through glass vias (TGVs) panels, for example, inspection systems are adapting to new challenges. Inspection systems for substrates such as semiconductor wafers and/or panels, including through glass via (TGV) panels or other panels, include a top plate assembly that includes a top plate (or “chuck”). The top plate holds the substrate, for example, in place during inspection. The top plate further includes a reflector plate or source of illumination that is used for inspecting the substrate. The inventors have recognized that a problem with existing inspection systems is that the reflector plate, for example, is affixed or fastened to the top assembly. The present inventors have recognized the desirability of being able to quickly change a reflector plate during inspection.

This disclosure describes a top plate design that allows a quick change of the reflector plates, for example, in the top plate assembly. Using various techniques of this disclosure, the reflector plates or, in some examples, sources of illumination, are held in place by a vacuum during operation. This technique holds the reflector plates securely without top-side fixturing, maximizing the available active area of the substrate. A vacuum secures the substrate without contacting the active areas, allowing for non-contact inspection and metrology. The top plate also facilitates the use of interchangeable reflector plates, enabling backlit or reflective illumination of the substrate’s features.

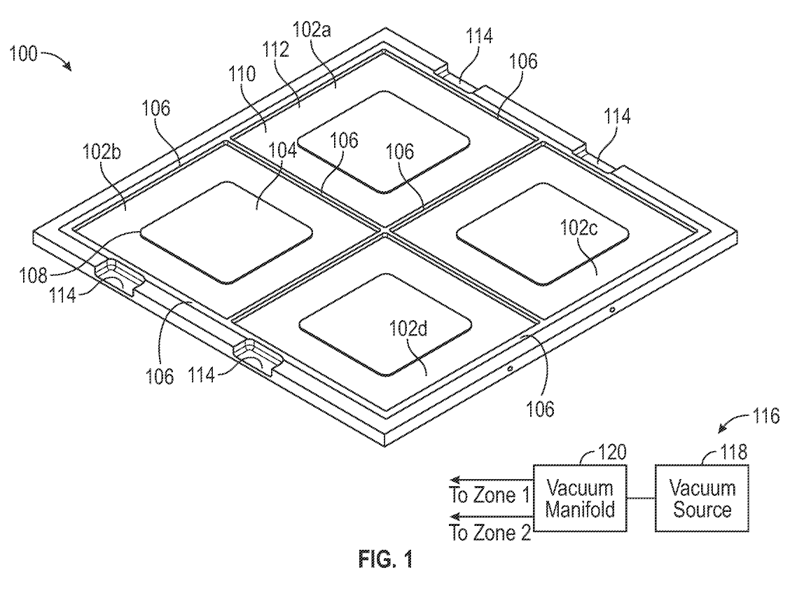

FIG. 1 is a perspective view of an example of a top plate of an inspection system in accordance with this disclosure. The top plate 100 (or “chuck”) shown includes four sections, namely sections 102a, 102b, 102c, and 102d, that align with four corresponding sections of a substrate, such as a semiconductor wafer or panel. Other top plates may include more than four sections or fewer than four sections, including a single section. Each section may be configured to receive a corresponding reflector plate or illumination source, for example. An illumination source may include a light source, such as light emitting diodes (LEDs), or a fluorescent source, for example, to provide backlighting for inspection of the substrate.

The top plate 100 includes various supports 106 that provide contact areas upon which the substrate rests. In some examples, the supports 106 contact the areas of the substrate that are not being inspected. The supports 106 include vacuum grooves that are coupled with a vacuum system to hold the substrate in place during inspection.

The top plate 100 also includes one or more vacuum grooves 108 coupled with a vacuum system 116. The vacuum system 116 includes a vacuum source 118 and, in some examples, a vacuum manifold 120. The vacuum manifold 120 may be coupled to multiple zones, such as the substrate zone 500 and the reflector zone 502 (or illumination zone 502) of FIG. 5 and configured to provide control of vacuum pressure to each zone. In some examples, the vacuum manifold 120 provides independent control of the vacuum pressure to the substrate zone and the reflector zone (or illumination zone).

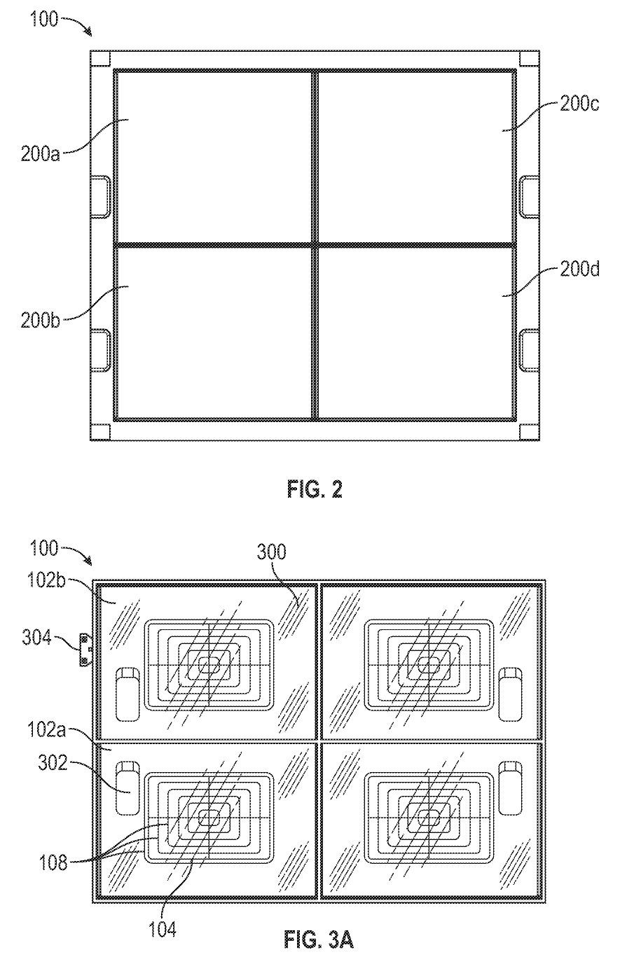

The vacuum grooves 108 hold down a reflector plate (or illumination source), such as the four reflector plates 200a, 200b, 200c, and 200d in FIG. 2. The vacuum system in the top plate 100 is designed to securely hold the substrate in place without contacting the active areas of the substrate. The active area of the substrate refers to regions where functional structures are fabricated and intended for device operation, such as integrated circuits and test structures. The vacuum system utilizes vacuum grooves 108 and small holes to create a suction force that keeps the substrate secured and stable during inspection. This non-contact technique ensures that the structures of the substrate, such as the vias of a panel, remain undisturbed and free from contamination.

In some examples, the vacuum system 116 is divided into separate zones, allowing for precise control and flexibility in handling different substrate configurations. This setup facilitates quick changes of reflector plates or illumination sources, enhancing the efficiency and adaptability of the inspection process.

Each section of the top plate 100 includes a horizontal bottom 110 coupled to the vertical support 106 that, along with the supports 106 of the section, define a cavity 112. A reflector plate or illumination source is positioned within a corresponding cavity 112. No panel or wafer is depicted in FIG. 1.

The top plate 100 may also include slots 114 (or pockets) integrated into the edges of the top plate 100, which facilitate loading and removal of the substrate, e.g., panel or wafer, from the top plate 100.

FIG. 2 is a top-down view of the top plate 100 of FIG. 1 including reflector plates 200a through 200d. The inspection system may utilize either one or more reflector plates or, in other examples, one or more illumination sources, also shown as illumination sources 200a through 200d, including fluorescent options, depending on the specific requirements of the inspection process. No panel or wafer is depicted in FIG. 2.

The four reflector plates 200a through 200d (or illumination sources 200a through 200d) correspond to the four sections 102a through 102d of FIG. 1. A reflector plate (or illumination source) is positioned beneath the panel and held in place by the vacuum system. The reflector plate provides reflective illumination, enhancing the contrast and visibility of features such as through glass vias (TGVs). Other than gravity and the force from the vacuum, no other forces in the vertical direction are applied to the reflector plate (or illumination source) or the panel (or wafer).

In some examples, one or more of the reflector plates may be specular reflective, diffuse reflective, opaque, or have various levels of reflectivity. In some examples, one or more of the reflector plates may be curved, such as to match the shape of the substrate. For example, a substrate such as a panel may droop near its center when the center is unsupported. A curved reflector plate may better match the shape of such a panel.

In other examples, an active illumination source is used instead of a reflector plate. An illumination source may include a light source, such as LEDs, an illumination panel, or a fluorescent source that provides transmitted light from beneath the panel. These illumination options enhance the visibility of the panel's features, allowing for precise inspection and metrology. The system's design allows for flexibility in using different types of illumination, accommodating various inspection needs and configurations. For conciseness, only top plate configurations with reflector plates are described but the design of the top plate 100 described in this disclosure is also configured to accommodate illumination sources.

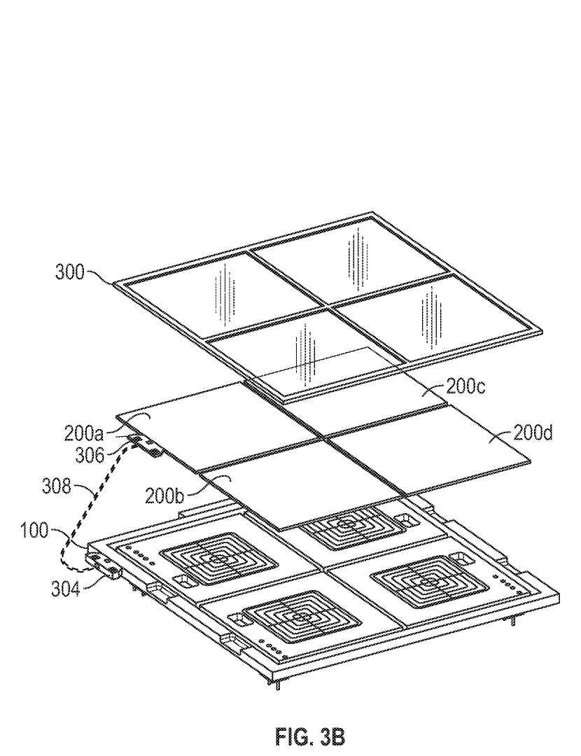

FIG. 3A is a top-down view of the top plate 100 of FIG. 1 including a substrate 300. In some examples, the substrate 300 is a semiconductor wafer. In some examples, the substrate 300 is a TGV panel or other panel. The panel or wafer is sized to cover all four sections 102a, 102b, 102c, and 102d.

As seen in FIG. 3A, the section 102a includes vacuum grooves 108 in the vacuum region 104 that are coupled with the vacuum system 116 of FIG. 1. The reflector plates (or illumination sources) are not depicted in FIG. 3A so as to illustrate the vacuum grooves 108. The section 102a also includes a finger slot 302. In some examples, the vacuum grooves 108 are in concentric squares to hold a reflector plate (or illumination source) in place. The vacuum grooves 108 include a plurality of outlets (shown in FIG. 5) coupled with the vacuum system 116 of FIG. 1.

The finger slot 302 is integrated into the top plate 100 to facilitate the removal and/or replacement of the reflector plates 200a through 200d of FIG. 2 (or illumination sources). The finger slot 302 allows an operator to position their fingers underneath a reflector plate, such as the reflector plate 200a of FIG. 2, and push the reflector plate upward to easily remove the reflector plate from the top plate 100 once the vacuum is no longer applied. This design improves the efficiency of the inspection process.

An electrical connector 304 is electrically coupled with a power source and configured to supply power to the illumination sources 200a through 200d of FIG. 2.

FIG. 3B is an exploded view of the top-down view of FIG. 3A. The exploded view of FIG. 3B depicts the top plate 100, the reflector plates 200a-200d of FIG. 2, and the substrate 300 of FIG. 3A.

An electrical connector 306 is electrically coupled with and configured to supply power to the illumination sources 200a through 200d, e.g., LEDs, via a cable 308 electrically coupled with the electrical connector 304.

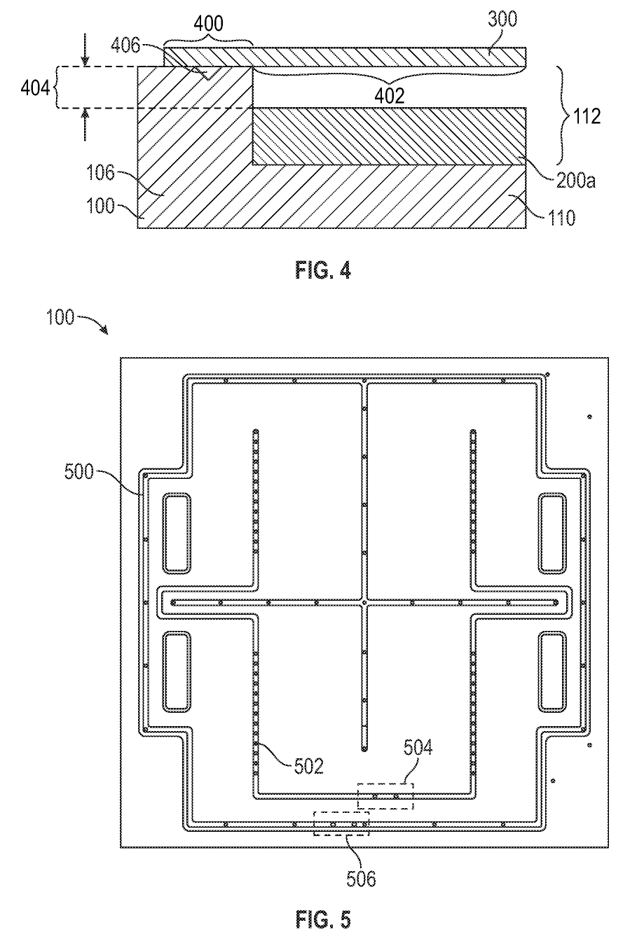

FIG. 4 is a cross-sectional view of an example of a portion of the top plate 100 including a reflector plate and a panel in accordance with this disclosure. The top plate 100 includes the bottom 110 that, along with the support 106, defines the cavity 112. A reflector plate 200a (or illumination source) is positioned within a corresponding cavity 112. The substrate 300 (e.g., panel or semiconductor wafer) includes a contact zone 400, e.g., a non-active area of the substrate 300, that rests on the support 106. The contact zone 400 represents a supported region of the substrate 300. A vacuum, such as from the vacuum system 116 of FIG. 1, secures the panel or wafer without contacting the active areas, allowing for non-contact inspection and metrology.

The substrate 300 also includes unsupported keep-out region 402, which includes the regions of the substrate 300 between the supports 106, such as shown in FIG. 1. The keep-out region 402 includes the active areas of the panel that are of interest for inspection (such as sections 102a through 102d in FIG. 1) and that are not in contact with the top plate, such as to prevent contamination, scratches, etc., to the panel or other substrate.

The unsupported keep-out regions 402 have an unsupported region depth 404, which is the distance between the top of the reflector plate 200a (or, in other examples, an illumination source 200a) and the bottom of the substrate 300. The unsupported region depth 404 may be adjusted or varied depending on the substrate. In some examples, the unsupported region depth 404 may be between 0 to 10 millimeters (mm).

FIG. 5 is a bottom view of the top plate 100 of FIG. 1. The bottom view in FIG. 5 depicts the two vacuum zones: a substrate zone 500 and a reflector zone 502. In examples using illumination sources, the reflector zone 502 is an illumination zone 502. The substrate zone 500 securely holds the panel (or wafer) in place during inspection. The supports 106 of FIG. 1 form part of the substrate zone 500, where the supports 106 of the substrate zone are designed to prevent contact with active areas of the panel or other substrate. The vacuum in this zone ensures that the panel is stabilized without contacting the active areas, allowing for non-contact inspection.

The reflector zone 502 (or illumination zone 502) securely holds the reflector plate (or illumination source) beneath the panel during inspection. The vacuum in this zone ensures that the reflector is securely positioned, enabling effective reflective imaging of the panel's features. This setup allows for quick changes of reflector plates or illumination sources.

The substrate zone 500 couples to outlets 506 and the reflector zone 502 includes outlets 504, where the outlets 504 and the outlets 506 may be connected to a manifold of the vacuum system 116 of FIG. 1. The manifold serves as a central hub that distributes vacuum pressure to the respective zones.

In some examples, the separation of these zones allows for independently controllable vacuum pressure to each of the substrate zone 500 and the reflector zone 502.

The top plate described above allows for the inspection of panels having a limited contact area that existing top plates cannot accommodate. Metrology/inspection requirements for panels may include via top, waist and bottom dimensions, via roundness, via taper angles, via to via pitch, as well as residue, bubbles, particles, surface cracks, and edge cracks or chipping. The new top plate described above assists with, among other things, imaging the TGV waist by providing backlight illumination to help enhance the contrast/image quality.

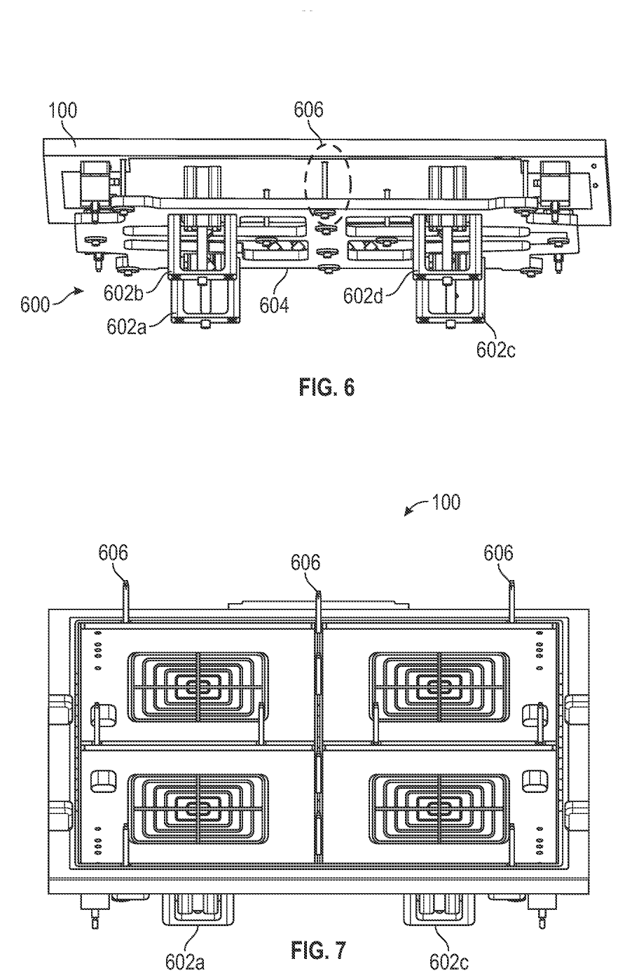

In some examples, it may be desirable to incorporate the top plate 100 into an automated inspection process. An example of a lift pin mechanism that may be combined with the top plate 100 for use in an automated inspection process is shown and described below with respect to FIGS. 6-8.

FIG. 6 is a perspective view of an example of a lift pin mechanism 600 coupled with the underside of the top plate 100 of FIG. 1. The lift pin mechanism 600 is used for automated loading/unloading of an substrate. The lift pin mechanism 600 of FIG. 6 is shown in an unactuated state.

In the example shown, the lift pin mechanism 600 includes four pneumatic actuators 602a, 602b, 602c, and 602d attached to a lift plate 604. In response to a control signal, the four pneumatic actuators 602a-602d move synchronously up and down to move the lift plate 604. There may be more than four or fewer than four pneumatic actuators.

Pins 606 are attached to the lift plate 604 and move with it. As shown in FIG. 7, when actuated, the pneumatic actuators push the lift plate 604, which extends the pins 606 through corresponding features of the top plate 100. The lift pin mechanism 600 of FIG. 6 is shown in an unactuated state.

FIG. 7 is a perspective view of the lift pin mechanism 600 of FIG. 6 shown in an actuated state. In FIG. 7, the four pneumatic actuators 602a-602d of FIG. 6 have actuated, which moves the lift plate 604 toward the top plate 100, thereby pushing the pins 606 through corresponding holes in the top plate 100.

Next, a robotic arm may move a substrate, e.g., panel or wafer, and position it onto the extended pins. A control signal controls the pneumatic actuators to move to an unactuated state, thereby lowering the pins 606 to position the substrate on the top plate 100 so that the substrate is ready for vacuum to be applied.

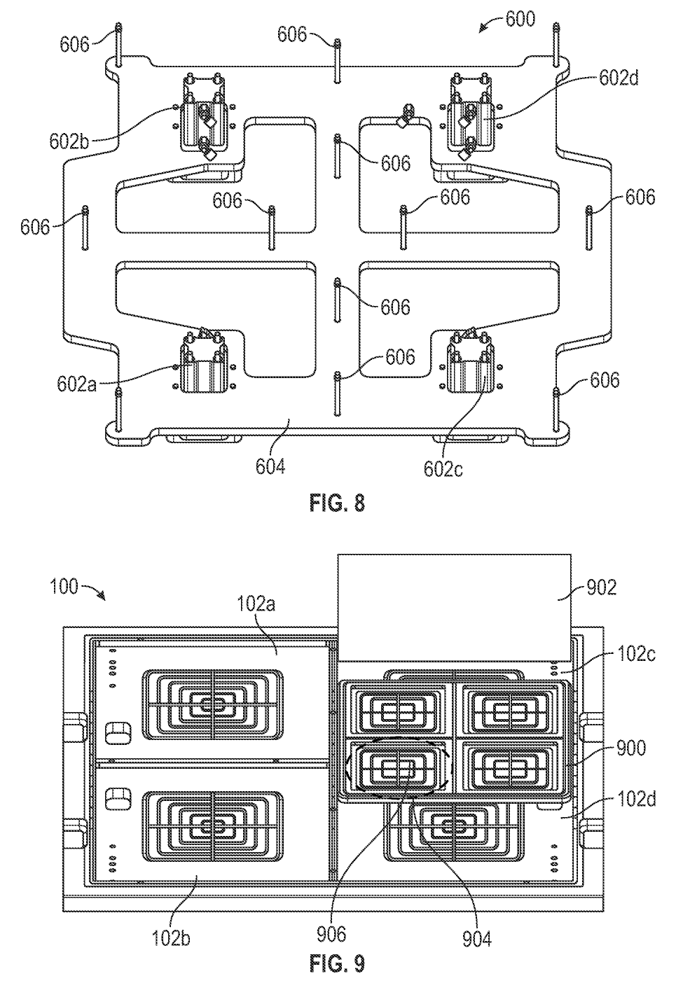

FIG. 8 is a perspective view of the lift pin mechanism 600 of FIG. 6 shown in isolation with the top plate. As seen in FIG. 8, the lift pin mechanism 600 includes a number of pins 606 around the periphery of the lift plate 604 as well as in its center to support a substrate.

As mentioned above, the substrate 300 of FIG. 3A is sized to cover all four of sections 102a, 102b, 102c, and 102d of FIG. 3A. However, in some examples, it may be desirable to be able to test a substrate that is smaller than the substrate 300 of FIG. 3A. As described below with respect to FIG. 9, an adapter plate may be used to test smaller substrates.

FIG. 9 is an exploded view depicting the top plate 100 of FIG. 3A with an example of an adapter plate 900. The adapter plate 900 may be configured to positioned within any one of sections 102a, 102b, 102c, and 102d of the top plate 100. In the example shown, the section 102d is shown receiving the adapter plate 900. A smaller panel 902 (or wafer or other substrate) is depicted above and ready to be positioned on the adapter plate 900. The smaller panel is sized to be positioned within section 102d. A reflector plate, such as the reflector plate 200d of FIG. 2, or an illumination source, is positioned between the smaller panel 902 and the adapter plate 900.

The adapter plate 900 includes vacuum region 904, which includes vacuum grooves 906. The vacuum grooves 906 may include outlets that align with the outlets 504 of the substrate zone 500 of FIG. 5 so that the vacuum system 116 of FIG. 1 may pull vacuum on the adapter plate 900. The adapter plate 900 is configured to hold the smaller panel 902 in, via the vacuum, during inspection. It should be noted that when the vacuum is applied, reflector plates or illumination sources are positioned within the remaining sections 102a, 102b, and 102c of the top plate that do not include the adapter plate 900.

The adapter plate 900 shown includes four vacuum regions. In other examples, the adapter plate 900 includes fewer than four vacuum regions, such as one or two vacuum regions. In other examples, the adapter plate 900 includes more than four vacuum regions.

The adapter plate 900 is desirable for scenarios where a large panel or wafer is not desirable or available, such as during research and development. A separate top plate 100 configured for use with only a smaller panel 902 may not be desirable because removal of a first top plate and installation of a second top plate may take several hours to ensure that the new top plate is level, etc. Then, the new top plate may need to be calibrated, which takes more time. With the adapter plate 900, no changeover is needed because the original top plate remains in place.

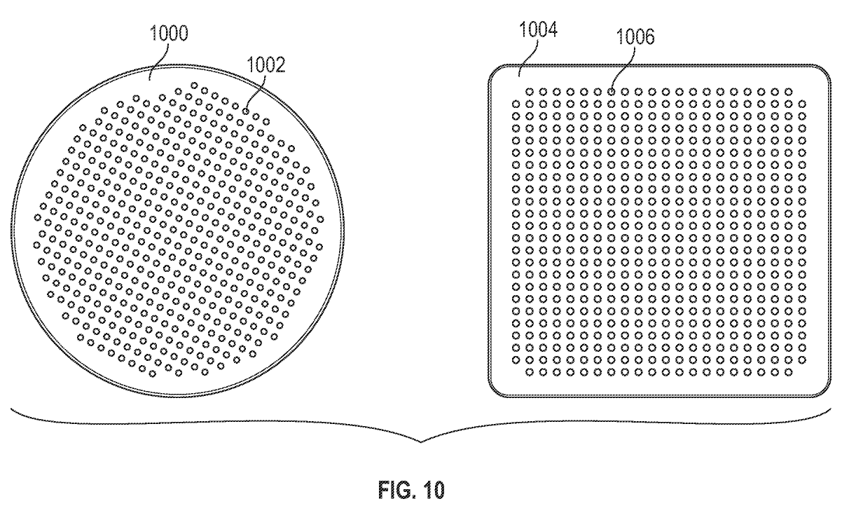

FIG. 10 depicts examples of a substrate. As mentioned above, the substrate 300 of FIG. 3B may be a wafer, such as the wafer 1000 of FIG. 10. The wafer 1000 includes features 1002, such as vias, that may be inspected using an inspection system.

In other examples, the substrate 300 of FIG. 3B may be a panel, such as the panel 1004 of FIG. 10. The panel 1004 includes features 1006, such as vias, that may be inspected using an inspection system.

### Various Notes

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A top plate for an inspection system, comprising:
a substrate zone configured to hold a substrate in place using a vacuum system, wherein the substrate zone is designed to prevent contact with active areas of the substrate; and
a reflector zone configured to hold a reflector plate positioned beneath the substrate in place using the vacuum system.

2. The top plate of claim 1, comprising:
a slot integrated into the top plate to facilitate loading and removal of the substrate from the top plate.

3. The top plate of claim 1, comprising:
a finger slot integrated into the top plate for removal of the reflector plate.

4. The top plate of claim 1, wherein the top plate is divided into two or more sections.

5. The top plate of claim 4, in combination with:
an adapter plate configured to be positioned within one section, wherein the adapter plate is configured to hold the substrate in place, wherein the substrate is sized to be positioned within the one section.

6. The top plate of claim 1, comprising:
a horizontal bottom coupled with a vertical support, wherein the horizontal bottom and the vertical support define a cavity, and wherein the cavity is configured to receive the reflector plate.

7. The top plate of claim 6, wherein a top of the reflector plate and a bottom of the substrate define an unsupported keep-out region within the cavity, and wherein the unsupported keep-out region has an unsupported region depth.

8. The top plate of claim 7, wherein the unsupported region depth is adjustable.

9. The top plate of claim 1, in combination with:
lift pin mechanism that is configured to be coupled with the top plate, wherein the lift pin mechanism includes:
a lift plate;
at least one pneumatic actuator coupled with the lift plate, the at least one actuator having an actuated state and an un-actuated state; and
a plurality of pins coupled with the lift plate and extending through the top plate, the plurality of pins configured for receiving the substrate during the actuated state.

10. A top plate for an inspection system, comprising:
a substrate zone configured to hold a substrate in place using a vacuum system, wherein the substrate zone is designed to prevent contact with active areas of the substrate; and
an illumination zone configured to hold an illumination source positioned beneath the substrate in place using the vacuum system.

11. The top plate of claim 10, comprising:
a slot integrated into the top plate to facilitate loading and removal of the substrate from the top plate.

12. The top plate of claim 10, comprising:
a finger slot integrated into the top plate to removal of the illumination source.

13. The top plate of claim 10, comprising:
a manifold connected to the substrate zone and the illumination zone, wherein the manifold is configured to provide control of vacuum pressure to the substrate zone and the illumination zone.

14. The top plate of claim 10, wherein the top plate is divided into two or more sections.

15. The top plate of claim 14, in combination with:
an adapter plate configured to be positioned within one section, wherein the adapter plate is configured to hold the substrate in place, wherein the substrate is sized to be positioned within the one section.

16. The top plate of claim 10, comprising:
a horizontal bottom coupled with a vertical support, wherein the horizontal bottom and the vertical support define a cavity, and wherein the cavity is configured to receive the illumination source.

17. The top plate of claim 16, wherein the substrate includes a contact zone including a non-active area, and wherein the vertical support is configured to contact the contact zone.

18. The top plate of claim 16, wherein a top of the illumination source and a bottom of the substrate define an unsupported keep-out region within the cavity, and wherein the unsupported keep-out region has an unsupported region depth.

19. The top plate of claim 18, wherein the unsupported region depth is adjustable.

20. The top plate of claim 10, in combination with:
lift pin mechanism that is configured to be coupled with the top plate, wherein the lift pin mechanism includes:
a lift plate;
at least one pneumatic actuator coupled with the lift plate, the at least one actuator having an actuated state and an un-actuated state; and
a plurality of pins coupled with the lift plate and extending through the top plate, the plurality of pins configured for receiving the substrate during the actuated state.
